(19) United States
(12) Patent Application Publication
(10) Pub. No.: US 2026/0088720 A1
(43) Pub. Date: Mar. 26, 2026

(54) SEMICONDUCTOR CIRCUIT AND POWER SUPPLY CIRCUIT

(71) Applicants: KABUSHIKI KAISHA TOSHIBA, Tokyo (JP); TOSHIBA ELECTRONIC DEVICES &STORAGE CORPORATION, Tokyo (JP)

(72) Inventor: Chen Kong TEH, Tokyo (JP)

(73) Assignees: KABUSHIKI KAISHA TOSHIBA, Tokyo (JP); TOSHIBA ELECTRONIC DEVICES &STORAGE CORPORATION, Tokyo (JP)

(21) Appl. No.: 19/046,603

(22) Filed: Feb. 6, 2025

(30) Foreign Application Priority Data
Sep. 24, 2024 (JP) 2024-165357

(51) Int. Cl. H02M 3/158; H02M 1/32

(52) U.S. Cl. CPC H02M 3/158; H02M 1/32

(57) ABSTRACT

According to one embodiment, a semiconductor circuit includes first to fifth transistors and an operational amplifier part. The first and second transistors includes one end connected to first and second nodes, respectively. The second transistor includes a gate connected to a gate and the other end of the first transistor. The third transistor includes one end connected to the other end of the first transistor. The fourth transistor includes one end connected to the other end of the second transistor and includes the other end connected to the other end of the third transistor. The operational amplifier part includes first and second input ends connected to the first and second nodes, respectively, and is configured to input, to a gate of the fourth transistor, a voltage corresponding to a voltage difference between a voltage at the first input end and a voltage at the second input end.

### CROSS-REFERENCE TO RELATED APPLICATIONS

This application is based upon and claims the benefit of priority from Japanese Patent Application No. 2024-165357, filed Sep. 24, 2024, the entire contents of which are incorporated herein by reference.

### FIELD

Embodiments described herein relate generally to a semiconductor circuit and a power supply circuit.

### BACKGROUND

There has been known a power supply circuit including a current protection circuit. The current protection circuit includes, for example, a current sensing circuit that detects, using an operational amplifier, a current flowing between an input terminal and an output terminal of the power supply circuit. The current protection circuit is configured to limit, on the basis of a result of current detection by the current sensing circuit, an output current of the power supply circuit so that the current does not become a predetermined value or more.

### BRIEF DESCRIPTION OF THE DRAWINGS

FIG. 1 is a circuit diagram illustrating an example of the circuit configuration of a power supply circuit provided with a power supply protection circuit according to a first embodiment.

FIG. 2 is a circuit diagram illustrating an example of a more detailed circuit configuration of the power supply circuit provided with the power supply protection circuit according to the first embodiment.

FIG. 3 is a schematic diagram illustrating a first example of the operation of the power supply protection circuit according to the first embodiment.

FIG. 4 is a schematic diagram illustrating a second example of the operation of the power supply protection circuit according to the first embodiment.

FIG. 5 is a circuit diagram illustrating an example of the circuit configuration of the power supply circuit provided with the power supply protection circuit according to a second embodiment.

FIG. 6 is a circuit diagram illustrating an example of a more detailed circuit configuration of the power supply circuit provided with the power supply protection circuit according to the second embodiment.

FIG. 7 is a timing chart illustrating an example of the operation of the power supply protection circuit according to the second embodiment.

FIG. 8 is a schematic diagram illustrating a first example of the operation of the power supply protection circuit according to the second embodiment.

FIG. 9 is a schematic diagram illustrating a second example of the operation of the power supply protection circuit according to the second embodiment.

FIG. 10 is a circuit diagram illustrating an example of the circuit configuration of the power supply circuit provided with the power supply protection circuit according to a third embodiment.

FIG. 11 is a schematic diagram illustrating a first example of the operation of the power supply protection circuit according to the third embodiment.

FIG. 12 is a schematic diagram illustrating a second example of the operation of the power supply protection circuit according to the third embodiment.

FIG. 13 is a circuit diagram illustrating an example of the circuit configuration of the power supply circuit provided with the power supply protection circuit according to a fourth embodiment.

FIG. 14 is a schematic diagram illustrating a first example of the operation of the power supply protection circuit according to the fourth embodiment.

FIG. 15 is a schematic diagram illustrating a second example of the operation of the power supply protection circuit according to the fourth embodiment.

FIG. 16 is a circuit diagram illustrating an example of the circuit configuration of the power supply circuit provided with the power supply protection circuit according to a fifth embodiment.

### DETAILED DESCRIPTION

In general, according to one embodiment, a semiconductor circuit includes first to fifth transistors and an operational amplifier part. The first transistor includes one end connected to a first node. The second transistor includes one end connected to a second node, which is different from the first node, and includes a gate connected to a gate and the other end of the first transistor. The third transistor includes one end connected to the other end of the first transistor and includes a gate to which a first reference voltage is input. The fourth transistor includes one end connected to the other end of the second transistor and includes the other end connected to the other end of the third transistor. The fifth transistor includes one end connected to the first node and includes a gate connected to the other end of the second transistor. The operational amplifier part includes a first input end connected to the first node and includes a second input end connected to the second node, and is configured to input, to a gate of the fourth transistor, a voltage corresponding to a voltage difference between a voltage at the first input end and a voltage at the second input end.

Hereinafter, an explanation will be given as to each of embodiments with reference to the drawings. Each of the embodiments exemplifies an apparatus or a method for embodying the technical idea of the invention. The drawings are schematic or conceptual. Constituent components having substantially identical functions and configurations are given the same reference numeral.

### <1>First Embodiment

The power supply protection circuit according to a first embodiment is calibrated to enable on-chip automatic calibration of the current sensing circuit. Hereinafter, an explanation will be given as to details of the power supply protection circuit according to the first embodiment.

### <1-1>Configuration

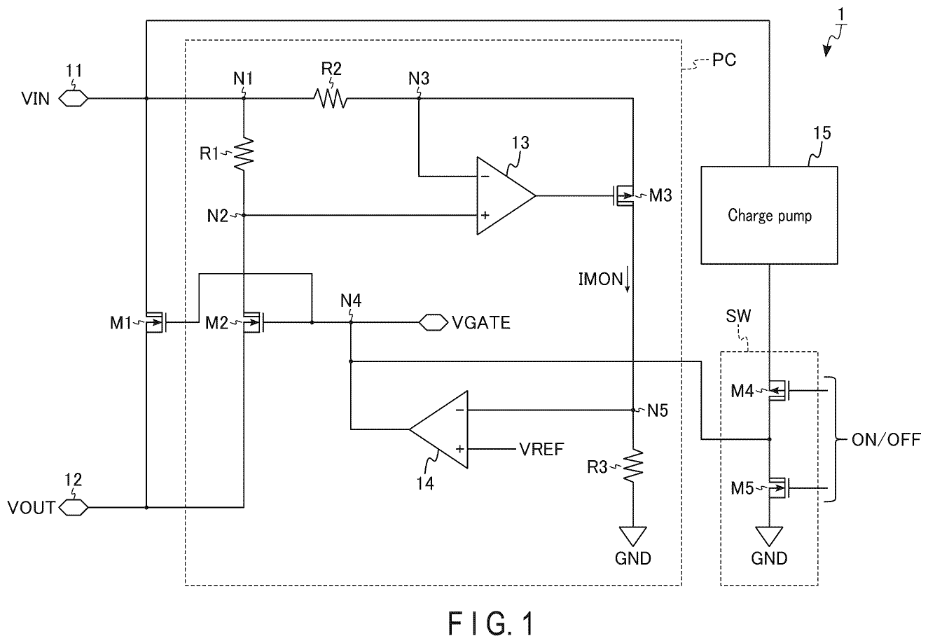

FIG. 1 is a circuit diagram illustrating an example of the circuit configuration of a power supply circuit 1 provided with a power supply protection circuit PC according to the first embodiment. As illustrated in FIG. 1, the power supply circuit 1 includes, for example, an input terminal 11, an output terminal 12, an operational amplifier part 13, an operational amplifier 14, a charge pump 15, transistors M1 to M5, resistors R1 to R3, nodes N1 to N5, and a ground node GND. Each of the transistors M1, M2 and M5 is an n-type high breakdown voltage MOSFET (Metal Oxide Semiconductor Field Effect Transistor). Each of the transistors M3 and M4 is a p-type high breakdown voltage MOSFET. A ground voltage is applied to the ground node GND.

The input terminal 11 is connected to an external power supply (not shown). As a power supply from outside, an input voltage VIN is supplied to the input terminal 11.

The input terminal 11 is connected to the node N1. The output terminal 12 can output an output voltage VOUT of the power supply circuit 1. The output terminal 12 is connected to a core circuit (not shown). The core circuit is configured to operate on the basis of the output voltage VOUT supplied from the power supply circuit 1.

The transistor M1 is connected between the input terminal 11 and the output terminal 12. More specifically, the drain of the transistor M1 is connected to the input terminal 11. The source of the transistor M1 is connected to the output terminal 12. One end of the resistor R1 is connected to the input terminal 11 via the node N1. The other end of the resistor R1 is connected to the drain of the transistor M2 via the node N2. The source of the transistor M2 is connected to the output terminal 12.

In this manner, between the input terminal 11 and the output terminal 12, the resistor R1 and the transistor M2 which are connected in series, and the transistor M1 are connected in parallel. Each of the gates of the transistor M1 and the transistor M2 is connected to the node N4. In this specification, gate voltages of the transistors M1 and M2 are referred to as “VGATE”. In the power supply circuit 1, a size ratio of the transistors M1 and M2 is 1:N. A gate-source voltage Vgs applied between the source and the gate of the transistor M1 is approximately equal to a gate-source voltage Vgs applied between the source and the gate of the transistor M2. In this manner, the transistors M1 and M2 constitute a current mirror circuit.

One end of the resistor R2 is connected to the input terminal 11 via the node N1. The other end of the resistor R2 is connected to the source of the transistor M3 via the node N3. The drain of the transistor M3 is connected to one end of the resistor R3 via the node N5. The other end of the resistor R3 is connected to the ground node GND. In this specification, the current flowing through the transistor M3 is referred to as “IMON.”

The operational amplifier part 13 is configured to control the gate voltage of the transistor M3 so that the voltage at the node N2 becomes equal to the voltage at the node N3. More specifically, the non-inverting input end (first input end) of the operational amplifier part 13 is connected to the node N2. The inverting input end (second input end) of the operational amplifier part 13 is connected to the node N3. The output end of the operational amplifier part 13 is connected to the gate of the transistor M3. The operational amplifier part 13 outputs a signal corresponding to a difference between the voltage at the first input end and the voltage at the second input end.

In this manner, the transistor M3 outputs a signal corresponding to the signal output from the operational amplifier part 13. In the power supply circuit 1, a resistance value of the resistor R1 and a resistance value of the resistor R2 are designed to be approximately equal. Therefore, the current IMON flowing through the transistor M3 is approximately equal to the current flowing through the resistor R1. The current IMON also flows through the resistor R3. Accordingly, the resistor R3 generates a voltage corresponding to the current flowing through the resistor R1.

The operational amplifier 14 is configured to control the gate voltage VGATE on the basis of a voltage at the node N5. More specifically, a predetermined reference voltage VREF is input to the non-inverting input (first input end) of the operational amplifier 14. The inverting input (second input end) of the operational amplifier 14 is connected to the node N5. The output terminal of the operational amplifier 14 is connected to the node N4.

Accordingly, the operational amplifier 14 can output a signal corresponding to a voltage difference between the first input end and the second input end to the gate of the transistor M1 and to the gate of the transistor M2.

The charge pump 15 generates a predetermined voltage on the basis of the input voltage VIN and outputs the generated voltage. The input end of the charge pump 15 is connected to the input terminal 11. The output end of the charge pump 15 is connected to the source of the transistor M4. The drain of the transistor M4 is connected to the drain of the transistor M5 via the node N4. The source of the transistor M5 is connected to the ground node GND. An on/off input signal is input to each of the gates of the transistors M4 and M5. In FIG. 1, a pair of the transistors M4 and M5 are illustrated as an on/off control circuit SW. The on/off control circuit SW includes the transistors M4 and M5 connected in series.

The voltage at the node N4, which corresponds to the connection node between the transistors M4 and M5, changes according to the on/off input signal. More specifically, in a case where the on/off input signal is at high level, conduction is made between the node N4 and the ground node GND via the transistor M5, and the voltage at the node N4 (gate voltage VGATE) becomes low level. Hence, the transistors M1 and M2 are brought into an off state, and the power supply circuit 1 does not output the output voltage VOUT from the output terminal 12. On the other hand, in a case where the on/off input signal is at low level, conduction is made between the charge pump 15 and the node N4 via the transistor M4, and the voltage at the node N4 (gate voltage VGATE) becomes high level. Hence, the transistors M1 and M2 are brought into an on state, and the power supply circuit 1 outputs the output voltage VOUT from the output terminal 12.

When the power supply circuit 1 is turned on, the current flowing into the transistor M2 also flows into the resistor R1. The pair of transistors M1 and M2 constitute a current mirror circuit. Thus, a current amount IM1 flowing into the transistor M1 and a current amount IM2 flowing into the transistor M2 have a proportional relationship. More specifically, the current amount IM2 becomes 1/N of the current amount IM1 according to a size ratio. The operational amplifier part 13 controls the transistor M3 so that the voltage at the node N2 and the voltage at the node N3 become equal. In other words, the current flowing into the resistor R1 and the current flowing into the resistor R2 are controlled to be equal. In a case where the voltage at the node N2 and the voltage at the node N3 are equal, the IMON becomes equal to the current amount IM2. The current flowing into the transistor M3 also flows into the resistor R3. Therefore, a voltage corresponding to the current flowing into the transistor M2 is generated at the node N5. The operational amplifier 14 controls each of the gate voltages (VGATE) of the transistors M1 and M2 so that the voltage at the node N4 becomes equal to the reference voltage VREF.

In the power supply circuit 1 described above, the set of the transistors M2 and M3, the resistors R1 to R3, the operational amplifier part 13, and the operational amplifiers 14 corresponds to the semiconductor circuit that functions as the power supply protection circuit PC according to the first embodiment. The power supply protection circuit PC detects the input current input from the input terminal 11. The transistor M3 outputs the current IMON corresponding to the input current. The power supply protection circuit PC is capable of adjusting each of the gate voltages of the transistors M1 and M2 on the basis of a comparison result between the voltage corresponding to the detected current amount (IMON) and the reference voltage VREF. Hereinafter, an explanation will be given as to a more detailed circuit configuration of the power supply protection circuit PC.

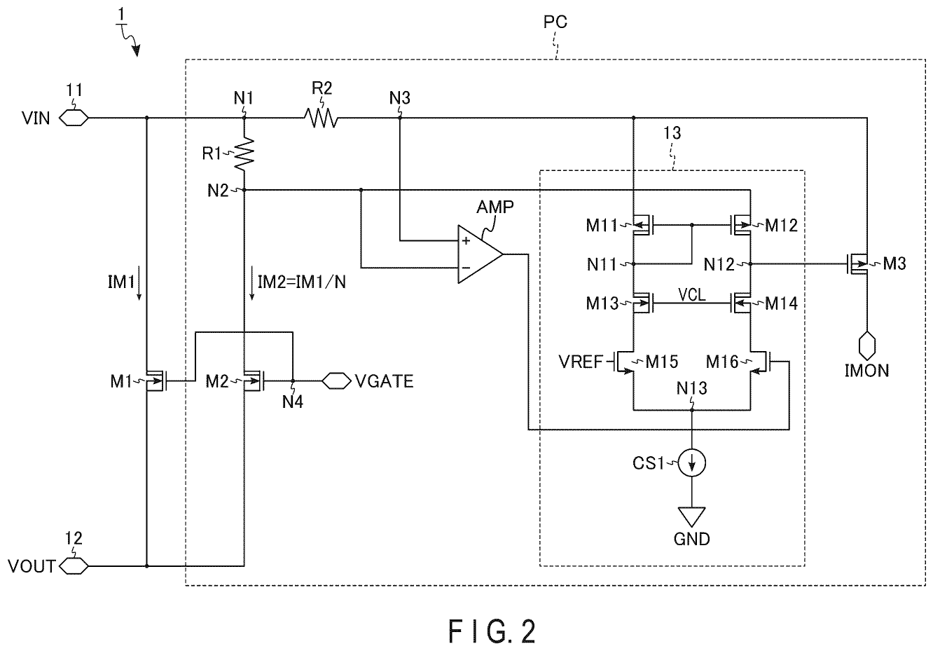

FIG. 2 is a circuit diagram illustrating an example of a more detailed circuit configuration of the power supply circuit 1 provided with the power supply protection circuit PC according to the first embodiment. In the drawings referenced below, part of the configuration of the power supply circuit 1 is appropriately omitted. As illustrated in FIG. 2, the power supply protection circuit PC according to the first embodiment further includes a calibration operational amplifier part AMP. The operational amplifier part 13 includes, for example, transistors M11 to M16, a constant current source CS1, and nodes N11 and N12. Each of the transistors M11 and M12 is the p-type high breakdown voltage MOSFET. Each of the transistors M13 and M14 is the n-type high breakdown voltage MOSFET. Each of the transistors M15 and M16 is, for example, an n-type low breakdown voltage MOSFET.

The source of the transistor M11 is connected to the node N3. The drain of transistor M11 is connected to the drain of the transistor M13 via the node N11. The source of the transistor M12 is connected to the node N2. The drain of the transistor M12 is connected to the drain of the transistor M14 via the node N12. Each of the gates of the transistors M11 and M12 is connected to the node N11. A size of the transistor M11 and a size of the transistor M12 are approximately equal. The transistors M11 and M12 constitute a current mirror circuit. The node N12 corresponds to the output end of the operational amplifier part 13. In other words, the node N12 is connected to the gate of the transistor M3.

The source of the transistor M13 is connected to the drain of the transistor M15. The source of the transistor M14 is connected to the drain of the transistor M16. A clamp voltage VCL is applied to each of the gate of the transistor M13 and the gate of the transistor M14. The clamp voltage VCL is a voltage higher than the ground voltage. The transistor M13 lowers the voltage on the source side on the basis of the clamp voltage VCL. The transistor M14 lowers the voltage on the source side on the basis of the clamp voltage VCL. A size of the transistor M13 and a size of the transistor M14 are approximately equal. As each of the transistors M13 and M14 clamps the voltage, low breakdown voltage MOSFETs may be used as the transistors connected to the nodes on the source side.

Each of the source of the transistor M15 and the source of the transistor M16 is connected to the node N13.

The reference voltage VREF is applied to the gate of the transistor M15. A size of the transistor M15 and a size of the transistor M16 are approximately equal.

The constant current source CS1 is connected between the node N13 and the ground node GND. With this configuration, the constant current source CS1 operates so that a total amount of the current flowed from the node N3 to the node N13 via the transistors M11, M13 and M15, and the current flowed from the node N2 to the node N13 via the transistors M12, M14 and M16 becomes constant.

The calibration operational amplifier part AMP is configured to control the gate voltage of the transistor M16 on the basis of an error between the voltage at the node N2 and the voltage at the node N3 to calibrate the operational amplifier part 13. More specifically, the non-inverting input (first input end) of the calibration operational amplifier part AMP is connected to the node N3. The inverting input (second input end) of the calibration operational amplifier part AMP is connected to the node N2.

The output end of the calibration operational amplifier part AMP is connected to the gate of the transistor M16.

With this configuration, the calibration operational amplifier part AMP can output, to the gate of the transistor M16, a signal corresponding to a voltage difference between the first input end and the second input end. The calibration operational amplifier part AMP outputs the reference voltage VREF in a case where the voltage at the first input end and the voltage at the second input end are equal.

In the power supply protection circuit PC according to the first embodiment described above, the transistors M3 and M11 to M14 function as a current sensing circuit. The transistors M15 and M16, the constant current source CS1, and the calibration operational amplifier part AMP function as a calibration amplifier.

### <1-2>Operation

Next, an explanation will be given as to the operation of the power supply protection circuit PC according to the first embodiment.

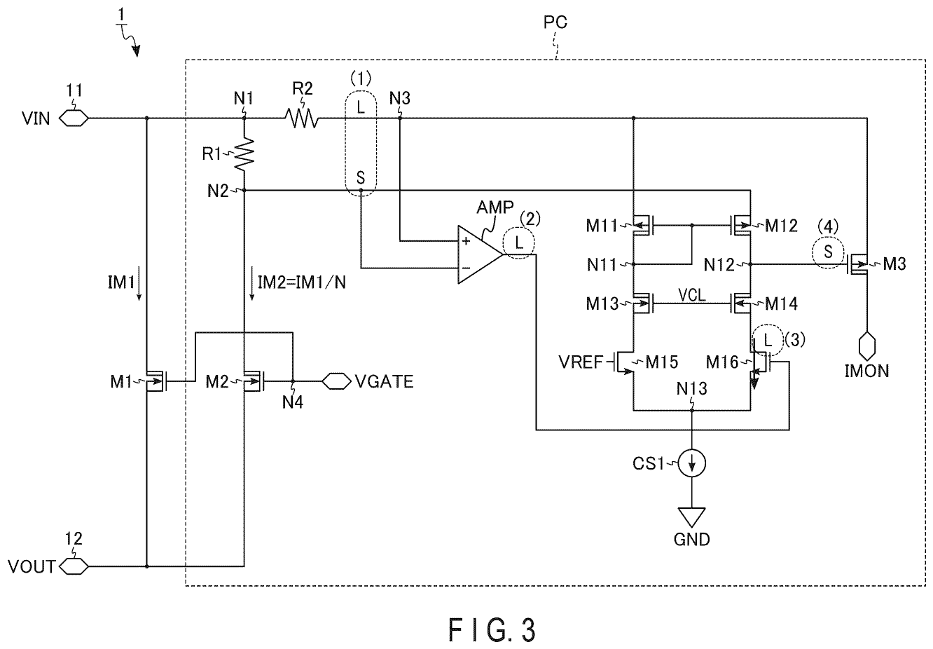

FIG. 3 is a schematic diagram illustrating a first example of the operation of the power supply protection circuit PC according to the first embodiment. FIG. 3 exemplifies the operation of the power supply protection circuit PC in a case where the voltage at the node N3 is higher than the voltage at the node N2. In this example, as indicated by (1) in FIG. 3, the voltage at the node N3 (L:large) is higher than the voltage at the node N2 (S:small). In this case, as indicated by (2) in FIG. 3, the calibration operational amplifier part AMP controls the output voltage so as to be higher than the reference voltage VREF (L:large). Then, as indicated by (3) in FIG. 3, the gate voltage of the transistor M16 becomes high and the amount of current flowing through the transistor M16 increases (L:large). As a result, as indicated by (4) in FIG. 3, the gate voltage of the transistor M3 drops down, and along with the increase in the amount of current flowing through the transistor M3, the voltage at the node 3 drops down.

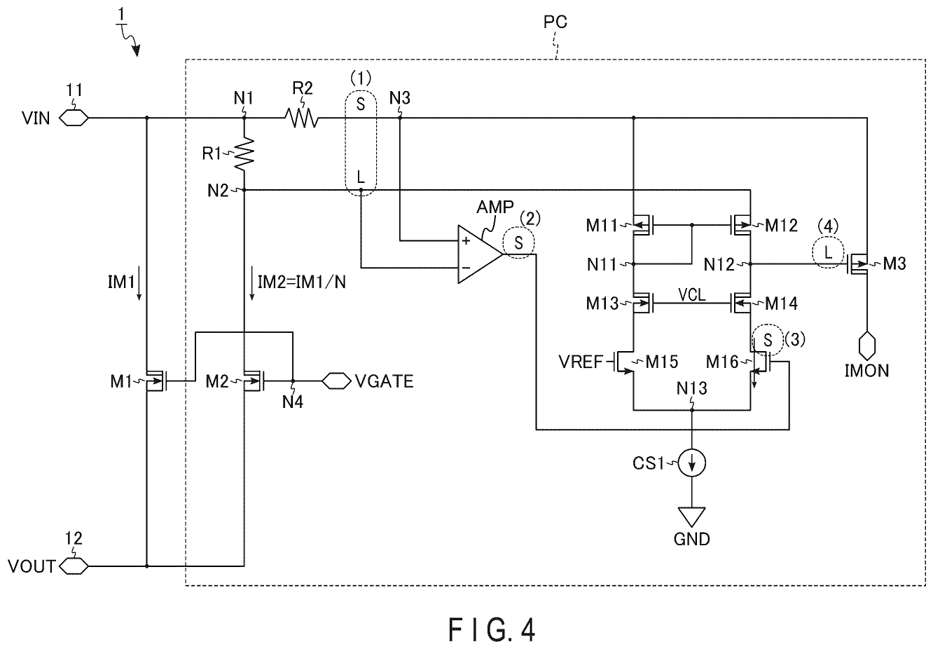

FIG. 4 is a schematic diagram illustrating a second example of the operation of the power supply protection circuit PC according to the first embodiment. FIG. 4 exemplifies the operation of the power supply protection circuit PC in a case where the voltage at the node N2 is higher than the voltage at the node N3. In this example, as indicated by (1) in FIG. 4, the voltage at the node N2 (L:large) is higher than the voltage at the node N3 (S:small). In this case, as indicated by (2) in FIG. 4, the calibration operational amplifier part AMP controls the output voltage so as to be lower than the reference voltage VREF (S:small). Then, as indicated by (3) in FIG. 4, the gate voltage of the transistor M16 becomes low and the amount of current flowing through the transistor M16 decreases (S:small). As a result, as indicated by (4) in FIG. 4, the gate voltage of the transistor M3 increases and the voltage at the node N3 increases along with decrease in the amount of current flowing through the transistor M3.

As explained above, the power supply protection circuit PC according to the first embodiment is capable of adjusting the gate voltage of the transistor M16 on the basis of the error between the voltage at the node N2 and the voltage at the node N3, and adjusting the amount of current flowing through the transistor M3.

### <1-3>Advantageous Effects of First Embodiment

In the power supply protection circuit PC according to the first embodiment, the operational amplifier part 13 is configured to be able to perform self-calibration, hence variation of the current amount IMON flowing through the transistor M3 is suppressed (reduced). With this configuration, the power supply protection circuit PC according to the first embodiment can perform on-chip calibration of the current sensing circuit automatically, and can improve the accuracy of current sensing. Therefore, the power supply circuit 1 provided with the power protection circuit PC according to the first embodiment can highly accurately limit the output current. Furthermore, since the power supply protection circuit PC according to the first embodiment is calibrated in a self-calibratable manner, the testing process can be simplified. As a result, the power supply protection circuit PC according to the first embodiment can suppress the manufacturing cost of the power supply circuit 1.

### <2>Second Embodiment

A second embodiment is related to a more specific circuit configuration of the calibration operational amplifier part AMP used as a calibration amplifier.

Hereinafter, an explanation will be given as to details of a power supply protection circuit PCa according to the second embodiment, mainly with respect to differences from the first embodiment.

### <2-1>Configuration

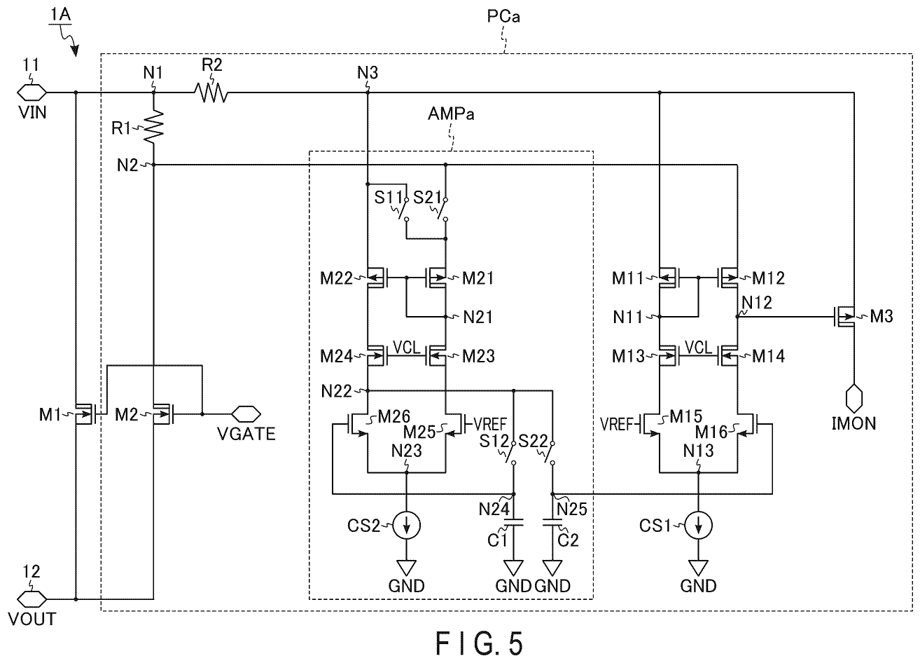

FIG. 5 is a circuit diagram illustrating an example of the circuit configuration of a power supply circuit 1A provide with the power supply protection circuit PCa according to the second embodiment. As illustrated in FIG. 5, compared to the power supply protection circuit PC according to the first embodiment, the power supply protection circuit PCa according to the second embodiment has the configuration in which the calibration operational amplifier part AMP is replaced with a calibration operational amplifier part AMPa. The calibration operational amplifier part AMPa includes, for example, transistors M21 to M26, capacitors C1 and C2, switches S11, S12, S21 and S22, a constant current source CS2, and nodes N21 to N25. Each of the transistors M21 and M22 is the p-type high breakdown voltage MOSFET. Each of the transistors M23 and M24 is the n-type high breakdown voltage MOSFET. Each of the transistors M25 and M26 is, for example, the n-type low breakdown voltage MOSFET.

A pair of the switches S11 and S12 and a pair of the switches S21 and S22 are, for example, complementarily controlled. In a case where the switches S11 and S12 are controlled to be in the on state, the switches S21 and S22 are controlled to be in the off state. In a case where the switches S21 and S22 are controlled to be in the on state, the switches S11 and S12 are controlled to be in the off state.

The source of the transistor M21 is connected to the node N3 via the switch S11 and also connected to the node N2 via the switch S21. The drain of the transistor M21 is connected to the drain of the transistor M23 via the node N21. The source of transistor M22 is connected to the node N3. The drain of the transistor M22 is connected to the drain of the transistor M24. Each of the gates of the transistors M21 and M22 is connected to the node N21. A size of the transistor M21 and a size of the transistor M22 are approximately equal. The transistors M21 and M22 constitute a current mirror circuit.

The source of the transistor M23 is connected to the drain of the transistor M25. The source of the transistor M24 is connected to the drain of the transistor M26 via the node N22. A clamp voltage VCL is applied to each of the gate of the transistor M23 and the gate of the transistor M24. The transistor M23 lowers the voltage on the source side on the basis of the clamp voltage VCL. The transistor M24 lowers the voltage on the source side on the basis of the clamp voltage VCL. A size of the transistor M23 and a size of the transistor M24 are approximately equal. As each of the transistors M23 and M24 clamps the voltage, low breakdown voltage MOSFETs may be used as the transistors connected to the nodes on the source side.

Each of the source of the transistor M25 and the source of the transistor M26 is connected to the node N23. the reference voltage VREF is applied to the gate of the transistor M25. A size of the transistor M25 and a size of the transistor M26 are approximately equal.

The constant current source CS2 is connected between the node N23 and the ground node GND. With this configuration, the constant current source CS2 operates so that a total amount of the current flowed from the node N2 or N3 to the node N23 via the transistors M21, M23 and M25, and the current flowed from the node N3 to the node N23 via the transistors M22, M24 and M26 becomes constant.

The node N22 is connected to the node N24 via the switch S12, and connected to the node N25 via the switch S22. The node N24 is connected to the gate of the transistor M26. The node N25 is connected to the gate of the transistor M16. Namely, the node N25 corresponds to the output end of the calibration operational amplifier part AMPa.

One end of the capacitor C1 is connected to the node N24. The other end of the capacitor C1 is connected to the ground node GND. With this connection, the capacitor C1 is configured to accumulate charges based on the voltage at the node N24. One end of the capacitor C2 is connected to the node N25. The other end of the capacitor C2 is connected to the ground node GND. With this connection, the capacitor C2 is configured to accumulate charges based on the voltage at the node N25.

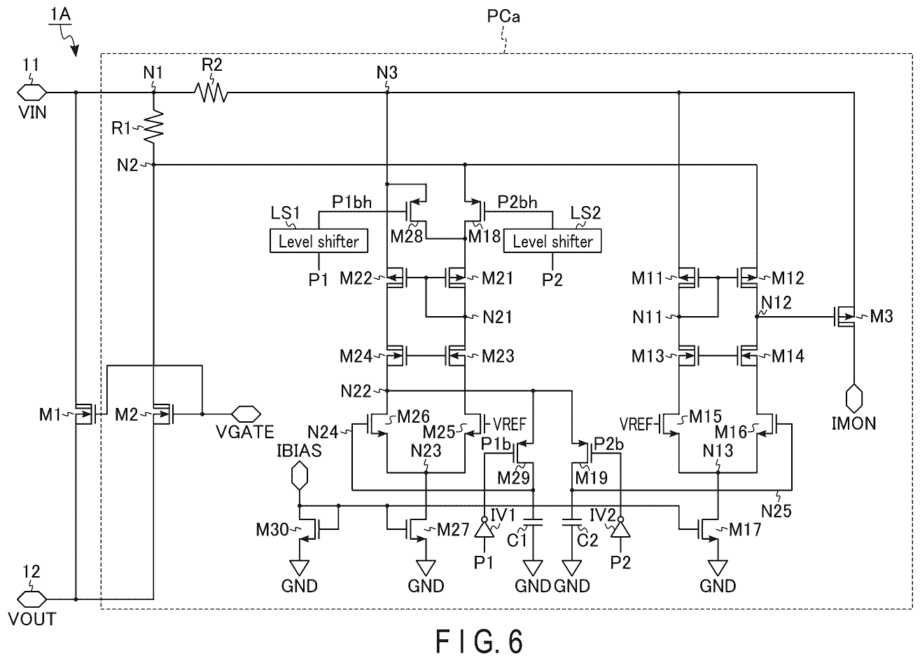

FIG. 6 is a circuit diagram illustrating an example of a more detailed circuit configuration of the power supply circuit 1A provided with the power supply protection circuit PCa according to the second embodiment. As illustrated in FIG. 6, the power supply protection circuit PCa according to the second embodiment further includes transistors M17 to M19 and M27 to M30, inverters IV1 and IV2, and level shifters LS1 and LS2. Each of the transistors M17, M27 and M30 is, for example, the n-type low breakdown voltage MOSFET. Each of the transistors M18, M19, M28 and M29 is, for example, a p-type low breakdown voltage MOSFET.

The drain of the transistor M17 is connected to the node N13. The drain of the transistor M27 is connected to the node N23. Each of the sources of the transistors M17, M27 and M30 is connected to the ground node GND. A voltage IBIAS is applied to each of the gate of the transistor M17, the gate of the transistor M27, and the drain and the gate of the transistor M30. A constant current based on the voltage IBIAS flows between the source and the drain of the transistor M30. Each of the transistors M17 and M27, when the voltage IBIAS is applied to the gates thereof, mirrors the constant current flowing through the transistor M30.

With this configuration, the transistors M17 and M27 function as the constant current sources CS1 and CS2, respectively.

The source of the transistor M28 is connected to the node N3. The source of the transistor M18 is connected to the node N2. Each of the drain of the transistor M28 and the drain of the transistor M18 is connected to the source of the transistor M21. Control signals P1 and P2 are respectively input to the level shifters LS1 and LS2. The level shifter LS1 inverts an input control signal P1 and inputs a level-shifted control signal P1bh to the gate of the transistor M28. The level shifter LS2 inverts an input control signal P2 and inputs a level-shifted control signal P2bh to the gate of the transistor M18. With this configuration, the transistors M28 and M18 function as the switches S11 and S21, respectively.

Each of the source of the transistor M29 and the source of the transistor M19 is connected to the node N22.

The drain of the transistor M29 is connected to the node N24. The drain of the transistor M19 is connected to the node N25. The control signals P1 and P2 are input to the inverters IV1 and IV2, respectively. The inverter IV1 inputs a control signal P1b, which is obtained by inverting the input control signal P1, to the gate of the transistor M29. The inverter IV2 inputs a control signal P2b, which is obtained by inverting the input control signal P2, to the gate of the transistor M19. With this configuration, the transistors M29 and M19 function as the switches S12 and S22, respectively.

### <2-2>Operation

Next, an explanation will be given as to the operation of the power supply protection circuit PCa according to the second embodiment. In this specification, the high-level voltage is a voltage that causes the n-type MOSFET, to which the voltage of this level was applied at the gate thereof, to be in the on state, and causes the p-type MOSFET, to which the voltage of this level was applied at the gate thereof, to be in the off state. The high-level voltage is, for example, 3V. The low-level voltage is a voltage that causes the n-type MOSFET, to which the voltage of this level was applied at the gate thereof, to be in the off state, and causes the p-type MOSFET, to which the voltage of this level was applied at the gate thereof, to be in the on state. The low-level voltage is, for example, 0 V. Vin is a voltage higher than the ground voltage. The ground voltage is, for example, 0 V.

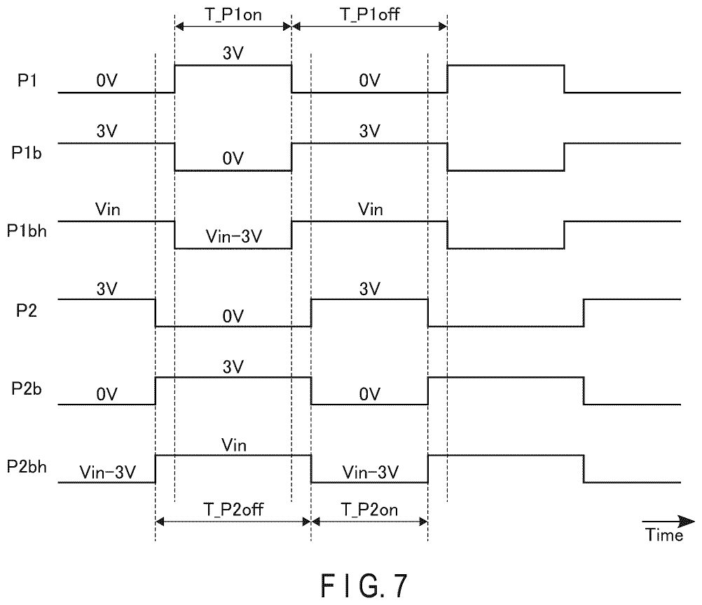

FIG. 7 is a timing chart illustrating an example of the operation of the power supply protection circuit PCa according to the second embodiment. FIG. 7 exemplifies the operation of each of the control signals P1, P1b, P1bh, P2, P2b, and P2bh in a case where the power supply circuit 1 is in the on state. As illustrated in FIG. 7, the control signals P1 and P2 are clock signals that are in mutually opposite phases and do not overlap with each other. More specifically, with respect to the control signals P1, P1b, and P1bh, control of a period T_P1on and control of a period T_P1off are alternately repeated. With respect to the control signals P2, P2b, and P1bh, the control of the period T_P1on and the control of the period T_P1off are alternately repeated.

In the period T_P1on, the control signal P1 is controlled to, for example, 3V (high level). In the period T_P1on, the control signal P1b is controlled to, for example, 0V (low level). In the period T_P1on, the control signal P1bh is controlled to, for example, Vin-3V (low level). With this control, in the period T_P1on, each of the transistors M28 and M29 is caused to be in the on state. In other words, in the period T_P1on, the switches S11 and S12 are controlled to be in the on state.

In the period T_P1off, the control signal P1 is controlled to, for example, 0V (low level). In the period T_P1off, the control signal P1b is controlled to, for example, 3V (high level). In the period T_P1off, the control signal P1bh is controlled to, for example, Vin (high level). With this control, in the period T_P1off, each of the transistors M28 and M29 is caused to be in the off state. In other words, in the period T_P1off, the switches S11 and S12 are controlled to be in the off state.

In the period T_P2on, the control signal P2 is controlled to, for example, 3V (high level). In the period T_P2on, the control signal P2b is controlled to, for example, 0V (low level). In the period T_P2on, the control signal P2bh is controlled to, for example, Vin-3V (low level). With this control, in the period T_P2on, each of the transistors M18 and M19 is caused to be in the on state. That is, in the period T_P2on, the switches S21 and S22 are controlled to be in the on state.

In the period T_P2off, the control signal P2 is controlled to, for example, 0V (low level). In the period T_P2off, the control signal P2b is controlled to, for example, 3V (high level). In the period T_P2off, the control signal P2bh is controlled to, for example, Vin (high level). With this control, in the period T_P2off, each of the transistors M18 and M19 is caused to be in the off state. That is, in the period T_P2off, the switches S21 and S22 are controlled to be in the off state.

The period T_P1on is included within the period T_P2off. The period T_P2on is included within the period T_P1off. In this way, the pair of the switches S11 and S12 and the pair of the switches S21 and S22 are controlled so as not to be turned on simultaneously. The period T_Plon may be set to be shorter than the period T_P2off. The period T_P2on may be set to be shorter than the period T_P1off. In FIG. 7, a case where part of the period T_P1off overlaps with part of the period T_P2off is exemplified.

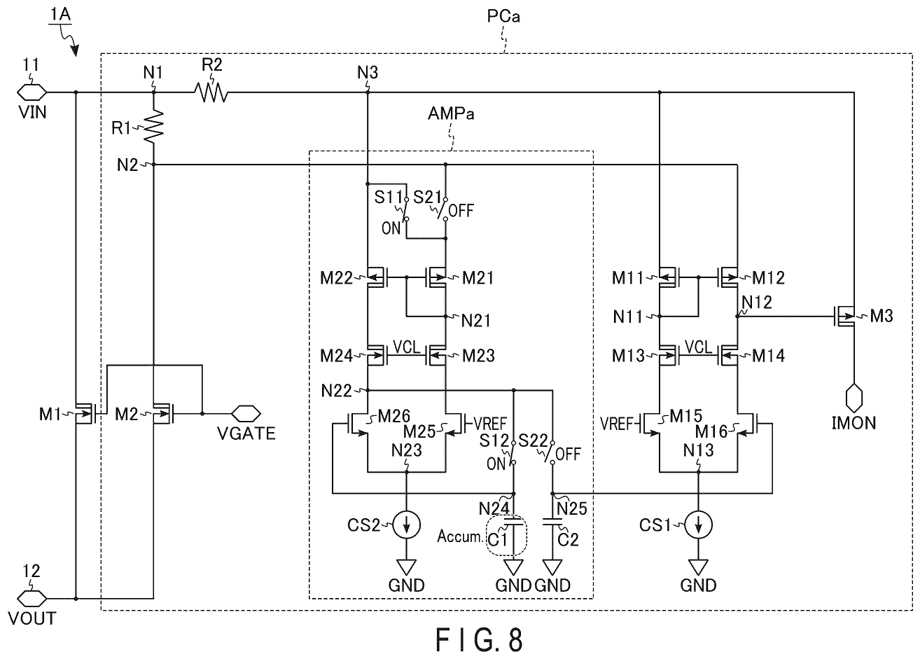

FIG. 8 is a schematic diagram illustrating a first example of the operation of the power supply protection circuit PCa according to the second embodiment. FIG. 8 exemplifies the operation of the power supply protection circuit PCa in a period in which the period T_P1on overlaps with the period T_P2off. As illustrated in FIG. 8, in this example, since the switch S11 is in the on state (ON) and the switch S21 is in the off state (OFF), respectively, a current flows into the node N23 from the node N3 via the transistors M21, M23, and M25, and a current flows into the node N23 from the node N3 via the transistors M22, M24, and M26.

In this example, since the switch S12 is in the on state (ON) and the switch S22 is in the off state (OFF), a current flows from the node N22 to the node N24 via the switch S12, and the node N24 can be charged. The capacitor C1 can accumulate the charges flowed into the node N24. Furthermore, the calibration operational amplifier part AMPa adjusts the voltage at the node N24, that is, adjusts the gate voltage of the transistor M26, so that a difference between the drain voltage of the transistor M21 and the drain voltage of the transistor M22 approaches zero.

More specifically, in the calibration operational amplifier part AMPa, in a case where the drain voltage of the transistor M21 is lower than the drain voltage of the transistor M22, the voltage at the node N24 (the gate voltage of the transistor M26) rises up, hence the amount of current flowing through the transistor M26 increases. As a result, the drain voltage of the transistor M22 drops down. On the other hand, in the calibration operational amplifier part AMPa, in a case where the drain voltage of the transistor M21 is higher than the drain voltage of the transistor M22, the voltage at the node N24 (the gate voltage of the transistor M26) drops down, hence the amount of current flowing through the transistor M26 decreases. As a result, the drain voltage of the transistor M22 rises up.

As explained above, in the period in which the period T_P1on overlaps with the period T_P2off, the calibration operational amplifier part AMPa, which functions as a calibration amplifier, may be calibrated. Incidentally, in the period in which the period T_P1on overlaps with the period T_P2off, the voltage at the node N25 becomes the voltage based on the charges accumulated in the capacitor C2.

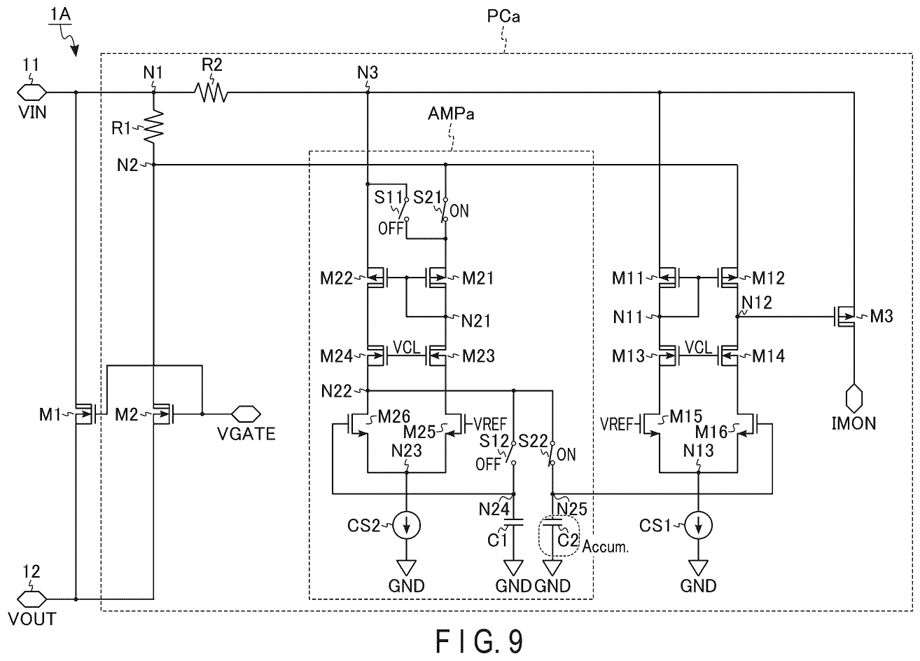

FIG. 9 is a schematic diagram illustrating a second example of the operation of the power supply protection circuit PCa according to the second embodiment. FIG. 9 exemplifies the operation of the power supply protection circuit PCa in the period in which the period T_P2on overlaps with the period T_P1off. As illustrated in FIG. 9, in this example, since the switch S11 is in the off state (OFF) and the switch S21 is in the on state (ON), a current flows into the node N23 from the node N3 via the transistors M22, M24 and M26, and a current flows into the node N23 from the node N2 via the transistors M21, M23 and M25.

Furthermore, in this example, since the switch S12 is in the off state (OFF) and the switch S22 is in the on state (ON), a current flows into the node N25 from the node N22 via the switch S22, hence the node N25 can be charged.

Then, the capacitor C2 can accumulate the charge flowed into the node N25. Furthermore, the calibration operational amplifier part AMPa adjusts the voltage at the node N25, that is, the gate voltage of the transistor M16, so that a difference between the voltage at the node N3 and the voltage at the node N2 approaches zero.

More specifically, in a case where the voltage at the node N3 is higher than the voltage at the node N2, the calibration operational amplifier part AMPa rises up the voltage at the node N25. As a result, the amount of the current flowing through the transistor M16 increases and the gate voltage of the transistor M3 drops down. With this, the amount of the current flowing through the transistor M3 increases and the voltage at the node N3 drops down. On the other hand, in a case where the voltage at the node N3 is lower than the voltage at the node N2, the calibration operational amplifier part AMPa drops down the voltage at the node N25. As a result, the amount of the current flowing through the transistor M16 decreases and the gate voltage of the transistor M3 rises up. Hence, the amount of the current flowing through the transistor M3 decreases and the voltage at the node N3 rises up.

As explained above, in the period in which the period T_P2on overlaps with the period T_P1off, the current sensing circuit (transistors M11 to M14) can be calibrated.

Additionally, in the period in which the period T_P1on overlaps with the period T_P2off, the voltage at the node N24 becomes the voltage based on the charges accumulated in the capacitor C1.

### <2-3>Advantageous Effects of Second Embodiment

In the power supply protection circuit PCa according to the second embodiment, the calibration operational amplifier part AMPa and the current sensing circuit are configured to be alternately calibratable, so that the accuracy of the calibration operational amplifier part AMPa can be more improved compared to the first embodiment. As a result, the power supply protection circuit PCa according to the second embodiment can suppress (reduce) the variation in the current amount IMON flowing through the transistor M3 more than the first embodiment, so that the accuracy of current sensing can be improved. Therefore, the power supply circuit 1A provided with the power supply protection circuit PCa according to the second embodiment can limit the output current more highly and accurately than the first embodiment. In addition, the power supply protection circuit PCa according to the second embodiment can, similar to the first embodiment, simplify the testing process and can suppress the manufacturing cost of the power supply circuit 1.

### <3>Third Embodiment

A power supply protection circuit PCb according to a third embodiment is a modified example of the power supply protection circuit PCb according to the second embodiment. Hereinafter, an explanation will be given as to details of the power supply protection circuit PCb according to the third embodiment, mainly with respect to differences from the first and second embodiments.

### <3-1>Configuration

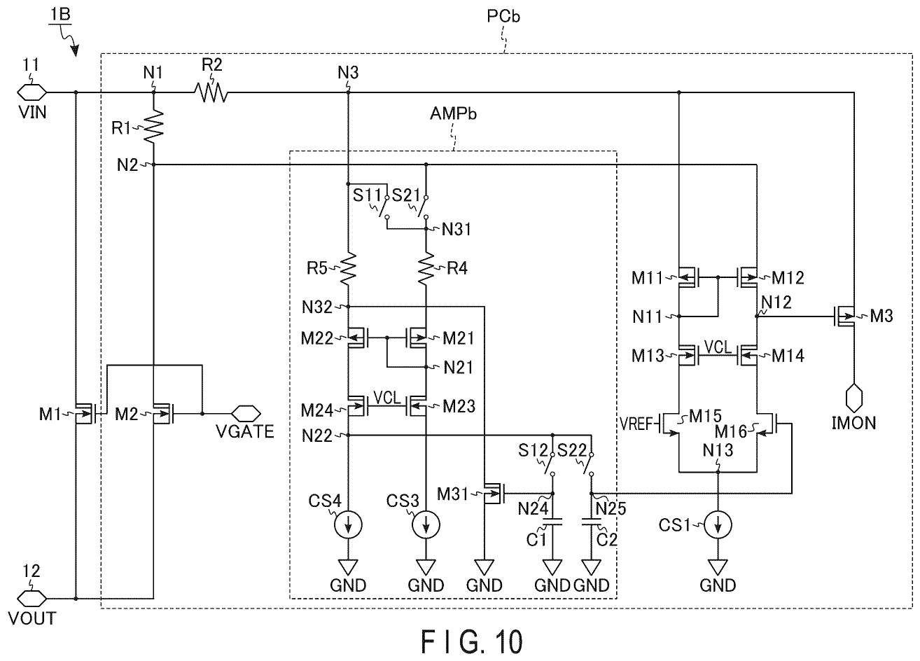

FIG. 10 is a circuit diagram illustrating an example of the circuit configuration of a power supply circuit 1B provided with the power supply protection circuit PCb according to the third embodiment. As illustrated in FIG. 10, the power supply protection circuit PCb according to the third embodiment has the configuration in which the calibration operational amplifier part AMPa of the power supply protection circuit PCa according to the second embodiment is replaced with a calibration operational amplifier part AMPb. The calibration operational amplifier part AMPb has the configuration in which, compared to the calibration operational amplifier part AMPa, the transistors M25 and M26, the constant current source CS2, and the node N23 are omitted, and resistors R4 and R5, constant current sources CS3 and CS4, a transistor M31, and nodes N31 and N32 are added. The transistor M31 is, for example, the n-type high breakdown voltage MOSFET.

The constant current source CS3 is connected between the source of the transistor M23 and the ground node GND.

The constant current source CS4 is connected between the source of the transistor M24 and the ground node GND. The switch S11 in the third embodiment is connected between the nodes N3 and N31. The switch S21 in the third embodiment is connected between the nodes N2 and N31. The source of the transistor M21 in the third embodiment is connected to the node N31 via the resistor R4. The source of transistor M22 in the third embodiment is connected to the node N32. The node N32 is connected to the node N3 via the resistor R5.

The drain of the transistor M31 is connected to the node N32. The source of the transistor M31 is connected to the ground node GND. The node N24 in the third embodiment is connected to the gate of the transistor M31.

### <3-2>Operation

Next, an explanation will be given as to the operation of the power supply protection circuit PCb according to the third embodiment. The method for controlling the switches S11, S12, S21 and S22 in the power supply protection circuit PCb according to the third embodiment is similar to the control method explained in the first embodiment with the use of FIG. 7.

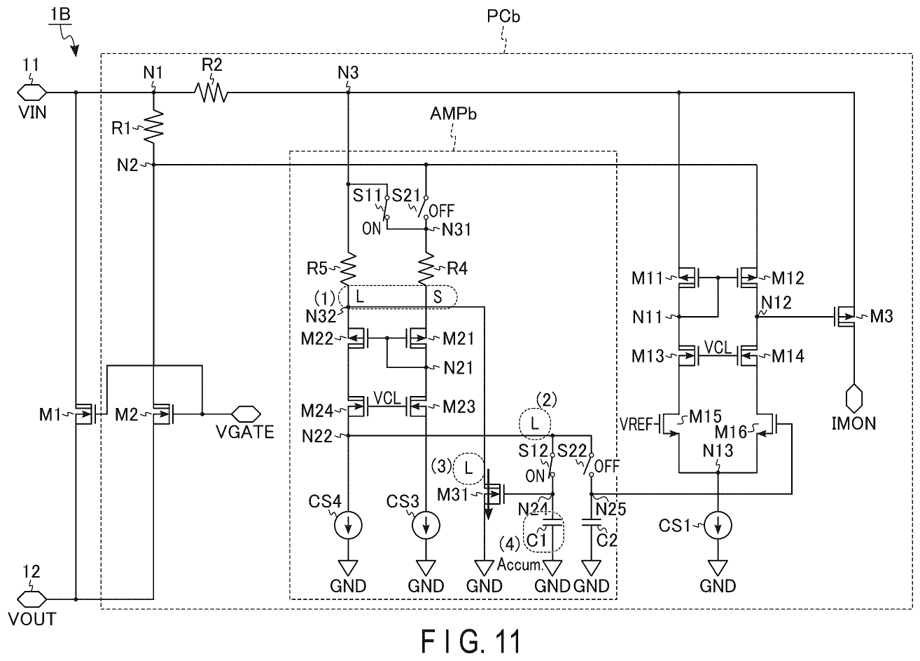

FIG. 11 is a schematic diagram illustrating a first example of the operation of the power supply protection circuit PCb according to the third embodiment. FIG. 11 exemplifies the operation of the power supply protection circuit PCb in the period in which the switches S11 and S12 are in the on state (ON), and the switches S21 and S22 are in the off state (OFF). The calibration operational amplifier part AMPb adjusts the voltage at the node N24, that is, the gate voltage of the transistor M31, so that a difference between the voltage of the resistor R5 and the voltage of the resistor R4 approaches zero.

In this example, as indicated by (1) in FIG. 11, the voltage of the resistor R5 (L:large) is higher than the voltage of the resistor R4 (S:small). In this case, in the calibration operational amplifier part AMPb, as indicated by (2) in FIG. 11, the voltage at the node N24 rises up (L:large). Consequently, as indicated by (3) in FIG. 11, the gate voltage of the transistor M31 rises up, the amount of the current flowing through the transistor M31 increases (L:large), and the voltage at the node N32 drops down. On the other hand, although not illustrated, in a case where the voltage of the resistor R5 is lower than the voltage of the resistor R4, the voltage at the node N24 drops down in the calibration operational amplifier part AMPb. Then, the gate voltage of the transistor M31 drops down, the current flowing through the transistor M31 decreases, and the voltage at the node N32 rises up.

As explained above, the calibration operational amplifier part AMPb, used as a calibration amplifier, can be calibrated by adjusting the gate voltage of the transistor M31. In addition, as indicated by (4) in FIG. 11, the capacitor C1 can accumulate charges flowing through the node N24. An amount of the charges accumulated in the capacitor C1 may vary depending on magnitudes of the voltages of the resistors R4 and R5.

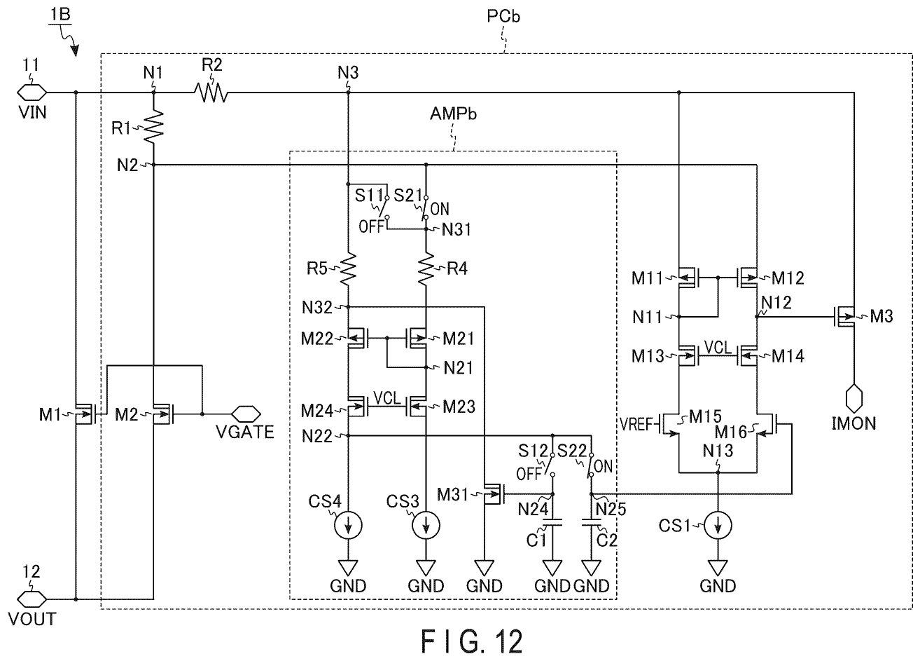

FIG. 12 is a schematic diagram illustrating a second example of the operation of the power supply protection circuit PCb according to the third embodiment. FIG. 12 exemplifies the operation of the power supply protection circuit PCb in the period in which the switches S11 and S12 are in the off state (OFF), and the switches S21 and S22 are in the on state (ON).

In this example, the current flows into the node N25 from the node N3 via the resistor R5, the transistors M22 and M24, and the switch S22, so that the node N25 can be charged. The capacitor C2 can accumulate the charges that flowed into the node N25. In addition, the current flows into the ground node GND from the node N2 via the switch S21, the resistor R4, and the transistors M21 and M23.

Furthermore, the calibration operational amplifier part AMPb adjusts the voltage at the node N25, that is, the gate voltage of the transistor M16, so that a difference between the voltage at the node N3 and the voltage at the node N2 approaches zero.

More specifically, in a case where the voltage at the node N3 is higher than the voltage at the node N2, the calibration operational amplifier part AMPb rises up the voltage at the node N25. As a result, the amount of the current flowing through the transistor M16 increases, and the gate voltage of the transistor M3 drops down.

Consequently, the amount of the current flowing through the transistor M3 increases and the voltage at the node N3 drops down. On the other hand, in a case where the voltage at the node N3 is lower than the voltage at the node N2, the calibration operational amplifier part AMPb drops down the voltage at the node N25. As a result, the amount of the current flowing through the transistor M16 decreases and the gate voltage of the transistor M3 rises up.

Consequently, the amount of the current flowing through the transistor M3 decreases and the voltage at the node N3 rises up.

As explained above, in the period in which the switches S11 and S12 are in the off state (OFF) and the switches S21 and S22 are in the on state (ON), the current sensing circuit (transistors M11-M14) can be calibrated. Incidentally, in the period in which the switches S11 and S12 are in the on state (ON) and the switches S21 and S22 are in the off state OFF), the voltage at the node N24 becomes a voltage based on the charges accumulated in the capacitor C1.

### <3-3>Advantageous Effects of Third Embodiment

The power supply protection circuit PCb according to the third embodiment, similar to the second embodiment, can suppress (reduce) the variation in the current amount IMON flowing through the transistor M3 and can improve the accuracy of the current sensing. Therefore, the power supply circuit 1B provided with the power supply protection circuit PCb according to the third embodiment can limit the output current more highly and accurately than the first embodiment. Additionally, the power supply protection circuit PCb according to the third embodiment can simplify the testing process, similar to the first embodiment, so that can suppress the manufacturing cost of the power supply circuit 1B.

### <4>Fourth Embodiment

A power supply protection circuit PCc according to a fourth embodiment is configured to perform calibration of the current sensing circuit with the use of two of the calibration operational amplifier parts AMP. Hereinafter, an explanation will be given as to details of the power supply protection circuit PCc according to the fourth embodiment, mainly with respect to differences from the first to third embodiments.

### <4-1>Configuration

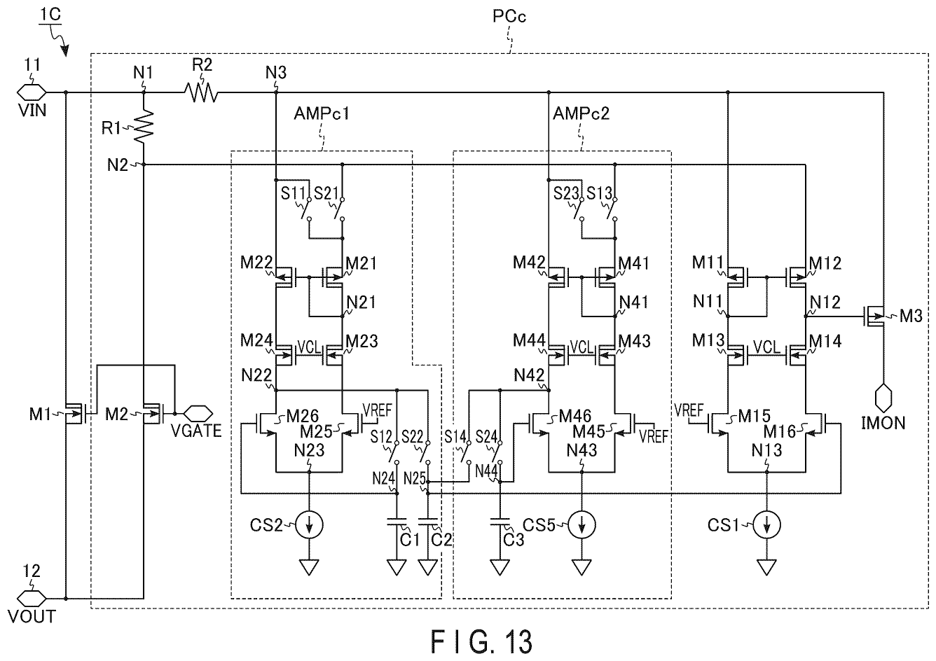

FIG. 13 is a circuit diagram illustrating an example of the circuit configuration of a power supply circuit 1C provided with the power supply protection circuit PCc according to the fourth embodiment. As illustrated in FIG. 13, the power supply protection circuit PCc according to the fourth embodiment has the configuration in which the calibration operational amplifier part AMPa of the power supply protection circuit PCa according to the second embodiment is replaced with two calibration operational amplifier parts, AMPc1 and AMPc2. The calibration operational amplifier part AMPc1 has the configuration similar to the calibration operational amplifier part AMPa. The calibration operational amplifier part AMPc2 includes, for example, transistors M41 to M46, a capacitor C3, switches S13, S14, S23, and S24, a constant current source CS5, and nodes N41 to N44. Each of the transistors M41 and M42 is the p-type high breakdown voltage MOSFET. Each of the transistors M43 and M44 is the n-type high breakdown voltage MOSFET. Each of the transistors M45 and M46 is, for example, the n-type low breakdown voltage MOSFET. A set of the switches S11 to S14 and a set of the switches S21 to S24 are controlled complementarily, for example.

The source of transistor M41 is connected to the node N2 via the switch S13 and also connected to the node N3 via the switch S23. The drain of the transistor M41 is connected to the drain of the transistor M43 via the node N41. The source of the transistor M42 is connected to the node N3. The drain of the transistor M42 is connected to the drain of the transistor M44. Each of the gates of the transistors M41 and M42 is connected to the node N41. A size of the transistor M41 and a size of the transistor M42 are approximately equal. The transistors M41 and M42 constitute a current mirror circuit.

The source of the transistor M43 is connected to the drain of the transistor M45. The source of the transistor M44 is connected to the drain of the transistor M46 via the node N42. A clamp voltage VCL is applied to each of the gate of the transistor M43 and the gate of the transistor M44. The transistor M43, on the basis of the clamp voltage VCL, lowers the voltage on the source side. The transistor M44, on the basis of the clamp voltage VCL, lowers the voltage on the source side. A size of the transistor M43 and a size of the transistor M44 are approximately equal. As each of the transistors M43 and M44 clamps the voltage, the low breakdown voltage MOSFETs may be used as transistors connected to the nodes on the source side.

Each of the source of the transistor M45 and the source of the transistor M46 is connected to the node N43.

The reference voltage VREF is applied to the gate of the transistor M45. A size of the transistor M45 and a size of the transistors M46 are approximately equal.

The constant current source CS5 is connected between the node N43 and the ground node GND. With this configuration, the constant current source CS5 operates so that a total amount of the current flowed into the node N43 from the node N2 or the N3 via the transistors M41, M43 and M45, and the current flowed into the node N43 from the node N3 via the transistors M42, M44 and M46 becomes constant.

Furthermore, the node N42 is connected to the node N25 via the switch S14 and also connected to the node N44 via the switch S24. The node N44 is connected to the gate of the transistor M46. One end of the capacitor C3 is connected to the node N44. The other end of the capacitor C3 is connected to the ground node GND. That is, the capacitor C3 is configured to accumulate charges based on the voltage at the node N44.

### <4-2>Operation

Next, an explanation will be given as to the operation of the power supply protection circuit PCc according to the fourth embodiment. The method for controlling the switches S11, S12, S21 and S22 in the power supply protection circuit PCc according to the fourth embodiment is similar to the control method explained in the first embodiment with the use of FIG. 7. Moreover, the method for controlling the switches S13 and S14 in the fourth embodiment is similar to the method for controlling the switches S11 and S12. The method for controlling the switches S23 and S24 in the fourth embodiment is similar to the method for controlling the switches S21 and S22.

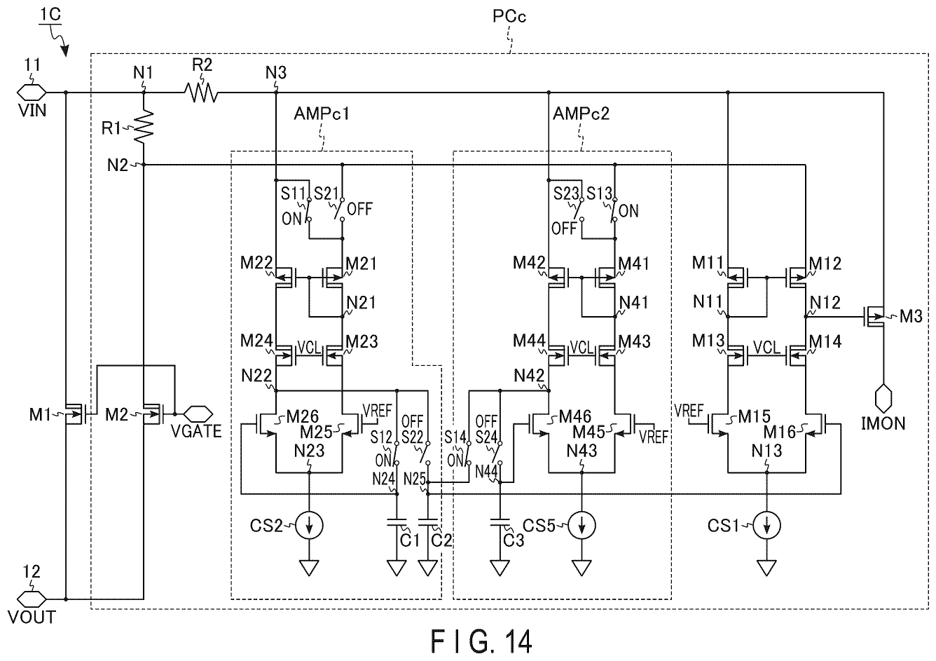

FIG. 14 is a schematic diagram illustrating a first example of the operation of the power supply protection circuit PCc according to the fourth embodiment. FIG. 14 exemplifies the operation of the power supply protection circuit PCc in the period in which the switches S11 to S14 are in the on state (ON), and the switches S21 to S24 are in the off state (OFF). In this example, the operation of the calibration operational amplifier part AMPc1 is similar to the operation of the calibration operational amplifier part AMPa explained in the second embodiment with the use of FIG. 8.

As illustrated in FIG. 14, in this example, in the calibration operational amplifier part AMPc2, the switch S13 is in the on state and the switch S23 is in the off state, respectively. Therefore, a current flows into the node N43 from the node N2 via the transistors M41, M43 and M45, and a current flows into the node 43 from the node N3 via the transistors M42, M44 and M46. In addition, in this example, since the switch S14 is in the on state and the S24 is in the off states, respectively, a current flows from the node N42 into the node N25 via the switch S14, so that the node N25 can be charged. Then, the capacitor C2 can accumulate the charges that flowed into the node N24. Moreover, the calibration operational amplifier part AMPc2 adjusts the voltage at the node N25, that is, the gate voltage of the transistor M16, so that a difference between the voltage at the node N3 and the voltage at the node N2 approaches zero.

In other words, in the period in which the switches S11 to S14 are in the on state (ON) and the switches S21 to S24 are in the off state (OFF), the calibration operational amplifier part AMPc1 performs self-calibration, while the calibration operational amplifier part AMPc2 performs calibration of the current sensing circuit.

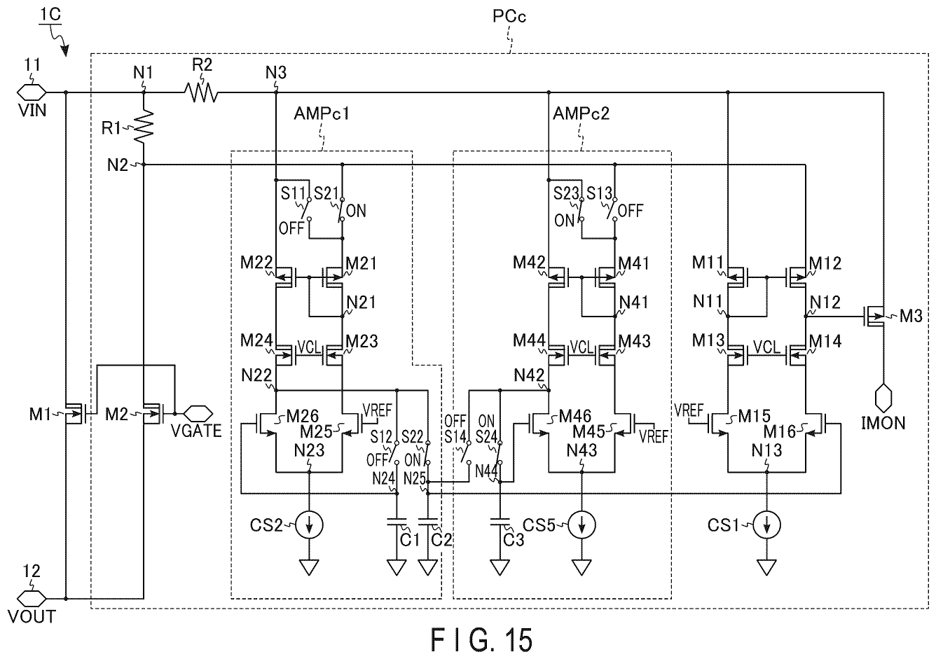

FIG. 15 is a schematic diagram illustrating a second example of the operation of the power supply protection circuit PCc according to the fourth embodiment. FIG. 15 exemplifies the operation of the power supply protection circuit PCc in the period in which the switches S11 to S14 are in the off state (OFF), and the switches S21 to S24 are in the on state (ON). In this example, the operation of the calibration operational amplifier part AMPc1 is similar to the operation of the calibration operational amplifier part AMPa described in the second embodiment with the use of FIG. 9.

As illustrated in FIG. 15, in this example, in the calibration operational amplifier part AMPc2, the switch S13 is in the off state (OFF) and the switch S23 is in the on state (ON), respectively. Therefore, a current flows into the node 43 from the node N3 via the transistors M41, M43 and M45, and a current flows into the node 43 from the node N3 via the transistors M42, M44 and M46. In addition, in this example, since the switch S14 is in the off state (OFF) and the S24 is in the on states (ON), respectively, a current flows from the node N42 into the node N44 via the switch S24, so that the node N44 can be charged. Further, the capacitor C3 can accumulate the charges flowed into the node N44. Furthermore, the calibration operational amplifier part AMPc2 adjusts the voltage at the node N24, that is, the gate voltage of the transistor M46, so that a difference between the source voltage of the transistor M41 and the source voltage of the transistor M42 approaches zero.

That is, in the period in which the switches S11 to S14 are in the off state (OFF) and the switches S21 to S24 are in the on state (ON), the calibration operational amplifier part AMPc1 performs calibration of the current sensing circuit, while the calibration operational amplifier part AMPc2 performs self-calibration.

### <4-3>Advantageous Effects of Fourth Embodiment

In the power supply protection circuit PCc according to the fourth embodiment, in the case where the power supply circuit 1C is in the on state, one of the calibration operational amplifier parts AMPc1 and AMPc2 performs self-calibration, while the other of the calibration operational amplifier parts AMPc1 and AMPc2 performs calibration of the current sensing circuit. In other words, the calibration operational amplifier parts AMPc1 and AMPc2 alternately perform the self-calibration and the calibration of the current sensing circuit.

By this operation, the power supply protection circuit PCc according to the fourth embodiment can suppress (reduce) a variation in the gate voltage of the transistor M16, which is used to adjust the gate voltage of the transistor M3, more effectively than the second embodiment and can improve the accuracy of current sensing.

Accordingly, the power supply circuit 1C provided with the power supply protection circuit PCc according to the fourth embodiment can limit the output current more highly and accurately than the second embodiment. Further, the power supply protection circuit PCc according to the fourth embodiment, similar to the first embodiment, can simplify the testing process and can suppress the manufacturing cost of the power supply circuit 1C.

Furthermore, a total capacitance of the capacitors C1 to C3 provided in the power supply protection circuit PCc according to the fourth embodiment may be designed to be smaller than a total capacitance of the capacitors C1 and C2 provided in the power supply protection circuit PC1. In other words, in the power supply protection circuit PCc according to the fourth embodiment, compared to the power supply protection circuit PCa according to the second embodiment, the total capacitance can be reduced. The reason for this is that, in the power supply protection circuit PCc according to the fourth embodiment, the frequency at which the capacitor C2 is charged is higher than the second embodiment, and the capacitance of the capacitor C2, which is used to control the gate voltage of the transistor M16, can be reduced. As a result, the power supply protection circuit PCc according to the fourth embodiment can reduce the chip size more than that of the second embodiment and can reduce the manufacturing cost of the power supply protection circuit PCc.

### <5>Fifth Embodiment

A power supply protection circuit PCd according to a fifth embodiment has a configuration in which cascode-connected transistors are added to the power supply protection circuit PCc according to the fourth embodiment. Hereinafter, an explanation will be given as to details of the power supply protection circuit PCd according to the fifth embodiment, mainly with respect to differences from the first to fourth embodiments.

### <5-1>Configuration

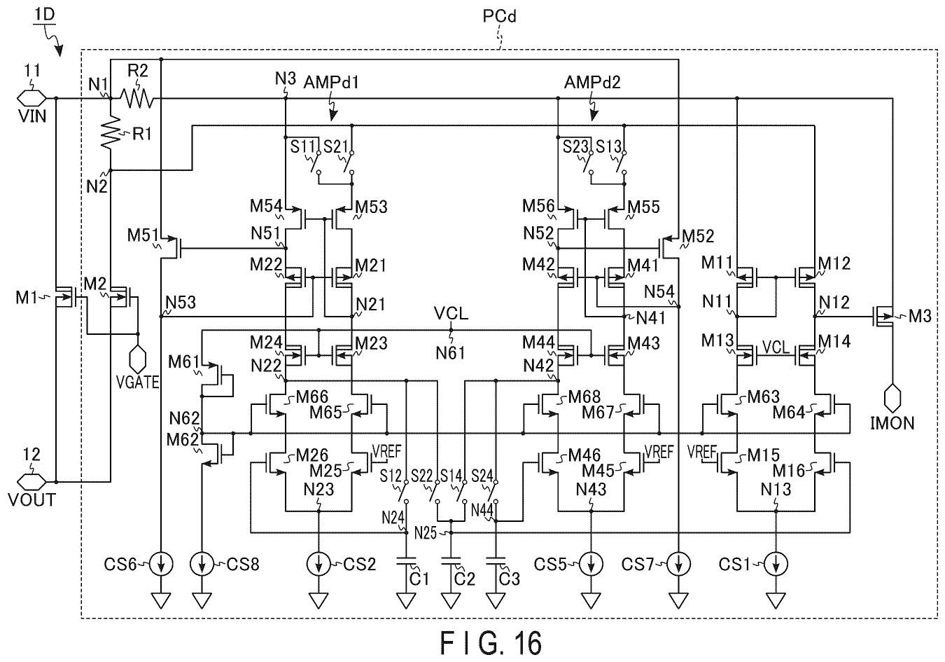

FIG. 16 is the circuit diagram illustrating an example of the circuit configuration of a power supply circuit 1D provide with the power supply protection circuit PCd according to the fifth embodiment. As illustrated in FIG. 16, the power supply protection circuit PCd according to the fifth embodiment has the configuration in which transistors M51 to M56, M61 to M68, constant current sources CS6 to CS8, and nodes N51 to N54, N61 and N62 are added to the power supply protection circuit PCc according to the fourth embodiment. Each of the transistors M51 to M56 and M61 is, for example, a low breakdown voltage PMOS transistor. Each of the transistors M62 to M68 is, for example, a low breakdown voltage NMOS transistor.

The source of the transistor M51 is connected to the node N1. The drain of the transistor M51 is connected to the node N53. Each of the gates of the transistors M21 and M22 in the fifth embodiment is connected, not to the node N21, but to the node N53. The constant current source CS6 is connected between the node N53 and the ground node GND. The constant current source CS6 operates so that the amount of the current flowed via the transistor M51 becomes constant.

The source of the transistor M52 is connected to the node N1. The drain of the transistor M52 is connected to the node N54. Each of the gates of the transistors M41 and M42 in the fifth embodiment is connected, not to the node N41, but to the node N54. The constant current source CS7 is connected between the node N54 and the ground node GND. The constant current source CS7 operates so that the amount of the current flowed via the transistor M52 becomes constant.

The source of the transistor M53 is connected to the node N3 via the switch S11 and also to the node N2 via the switch S21. The drain of the transistor M53 is connected to the source of the transistor M21. The source of the transistor M54 is connected to the node N3. The drain of the transistor M54 is connected to the source of the transistor M22 via the node N51. The node N51 is connected to the gate of the transistor M51. Each of the gates of the transistors M53 and M54 is connected to the node N21.

The source of the transistor M55 is connected to the node N3 via the switch S23 and also to the node N2 via the switch S13. The drain of the transistor M55 is connected to the source of the transistor M41. The source of the transistor M56 is connected to the node N3. The drain of the transistor M56 is connected to the source of the transistor M42 via the node N52. The node N52 is connected to the gate of the transistor M52. Each of the gates of the transistors M55 and M56 is connected to the node N41.

Each of the gates of the transistors M23, M24, M43 and M44, and the source of the transistor M61, are connected to the node N61. The clamp voltage VCL is applied to the node N61. The drain and gate of the transistor M61 are connected to the node N62. The drain and the gate of the transistor M62 are connected to the node N62. The node N62 is connected to each of the gates of the transistors M63 to M68. The constant current source CS8 is connected between the source of the transistor M62 and the ground node GND. The constant current source CS8 operates so that the amount of the current flowed via the transistor M62 becomes constant.

The transistor M63 is connected between the transistor M13 and the transistor M15. More specifically, the drain of the transistor M63 is connected to the source of the transistor M13, and the source of the transistor M63 is connected to the drain of the transistor M15. The transistor M64 is connected between the transistors M14 and M16. More specifically, the drain of the transistor M64 is connected to the source of the transistor M14, and the source of the transistor M64 is connected to the drain of the transistor M16. A size of the transistor M63 and a size of the transistor M64 are approximately equal.

The transistor M65 is connected between the transistor M23 and the transistor M25. More specifically, the drain of the transistor M65 is connected to the source of the transistor M23, and the source of the transistor M65 is connected to the drain of the transistor M25. The transistor M66 is connected between the transistor M24 and the transistor M26. More specifically, the drain of the transistor M66 is connected to the source of the transistor M24, and the source of the transistor M66 is connected to the drain of the transistor M26. A size of the transistor M65 and a size of the transistor M66 are approximately equal.

The transistor M67 is connected between the transistor M43 and the transistor M45. More specifically, the drain of the transistor M67 is connected to the source of the transistor M43, and the source of the transistor M67 is connected to the drain of the transistor M45. The transistor M68 is connected between the transistor M44 and the transistor M46. More specifically, the drain of the transistor M68 is connected to the source of the transistor M44, and the source of the transistor M68 is connected to the drain of the transistor M46. A size of the transistor M67 and a size of the transistor M68 are approximately equal.

### <5-2>Operation

The operation of the power supply protection circuit PCd according to the fifth embodiment is similar to that of the fourth embodiment.

### <5-3>Advantageous Effects of Fifth Embodiment

In the power supply protection circuit PCd according to the fifth embodiment, the transistors M51 to M56 and M61 to M68 form cascode connections. With this configuration, the power supply protection circuit PCd according to the fifth embodiment can reduce the variation in the current IMON flowing through the transistor M3 more effectively than the fourth embodiment and can improve the accuracy of current sensing. Therefore, the power supply circuit 1D provided with the power supply protection circuit PCd according to the fifth embodiment can limit the output current more highly and accurately than the fourth embodiment.

### <6>Others

The circuit configurations described in the above embodiments are merely examples. For example, in the power supply protection circuit PC according to the first embodiment, the transistors M13 and M14 may be omitted. In the power supply protection circuit PCa according to the second embodiment, the transistors M13, M14, M23 and M24 may be omitted. In the power supply protection circuit PCb according to the third embodiment, the transistors M13, M14, M23 and M24 may be omitted. In the power supply protection circuit PCc according to the fourth embodiment, the transistors M13, M14, M23, M24, M43 and M44 may be omitted. In the power supply protection circuit PCd according to the fifth embodiment, the transistors M13, M14, M23, M24, M43, M44, and M61 to M68 may be omitted.

Further, in the power supply protection circuit PCa according to the second embodiment, the switch S21 (transistor M18) illustrated in FIG. 5 and other figures may be connected to the side of the drain of the transistor M22 (for example, between the node N3 and the transistor M22), instead of being connected between the node N2 and the transistor M21. In the power supply protection circuit PCb according to the third embodiment, the switch S21 illustrated in FIG. 10 and other figures may be connected to the side of the drain of the transistor M22 (for example, between the node N3 and the resistor R5), instead of being connected between the nodes N2 and N31. In the power supply protection circuit PCc according to the fourth embodiment, the switch S21 illustrated in FIG. 13 and other figures may be connected to the source path of the transistor M22 (for example, between the node N3 and the transistor M22), instead of being connected between the node N2 and the transistor M21. In the power supply protection circuit PCc according to the fourth embodiment, the switch S13 illustrated in FIG. 13 and other figures may be connected to the source path of the transistor M42 (for example, between the node N3 and the transistor M42), instead of being connected between the node N2 and the transistor M41. In the power supply protection circuit PCd according to the fifth embodiment, the switch S21 illustrated in FIG. 16 may be connected to the source path of the transistor M22 (for example, between the node N3 and the transistor M54), instead of being connected between the node N2 and the transistor M53. In the power supply protection circuit PCd according to the fifth embodiment, the switch S13 illustrated in FIG. 16 may be connected to the source path of the transistor M42 (for example, between the node N3 and the transistor M56), instead of being connected between the node N2 and the transistor M55.

Furthermore, types of the transistors in the circuit configurations described in the above embodiments may be other combinations. As long as the operation similar to the above embodiments is possible, either the n-type transistor or the p-type transistor may be used. The fifth embodiment may be combined with any of the second to fourth embodiments. In other words, multiple transistors forming the cascode connection may be added to each of the power supply protection circuits PC, PCa and PCb. With this configuration, the variation in the current IMON flowing through the transistor M3 can further be improved. The reference voltage VREF input to the operational amplifier 14 and the reference voltage VREF used in the operational amplifier part 13 may be different from each other.

In this specification, the term “connection” indicates being electrically connected, and it does not exclude another element interposed in between, for example. To be “electrically connected,” an insulator may be interposed in between if it is operable in the manner similar to the operation of the one being electrically connected. A word line WL, selection gate lines SGD and SGS and the like may also be referred to as “wiring”. A node connecting certain elements may be referred to as a “connection node”. In this specification, one of the source and the drain of a transistor may be referred to as “one end” and the other one of the source and the drain may be referred to as “the other end”. In this specification, the switch S may be referred to as a “switching element”. In this specification, the size of a transistor may be compared on the basis of a gate length, a gate width and the like.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor circuit, comprising:
a first transistor including one end connected to a first node;
a second transistor including one end connected to a second node, which is different from the first node, and including a gate connected to a gate and the other end of the first transistor;
a third transistor including one end connected to the other end of the first transistor and including a gate to which a first reference voltage is input;
a fourth transistor including one end connected to the other end of the second transistor and including the other end connected to the other end of the third transistor;
a fifth transistor including one end connected to the first node and including a gate connected to the other end of the second transistor; and
an operational amplifier part including a first input end connected to the first node and including a second input end connected to the second node, and configured to input, to a gate of the fourth transistor, a voltage corresponding to a voltage difference between a voltage at the first input end and a voltage at the second input end.

2. The semiconductor circuit according to claim 1, further comprising:
a first resistor including one end connected to the first node;
a second resistor including one end connected to the second node and including the other end connected to the other end of the first resistor; and
a first constant current source connected between the other end of the third transistor and a ground node.

3. The semiconductor circuit according to claim 1, wherein
the first transistor, the second transistor, the third transistor, the fourth transistor, and the fifth transistor are each a p-type MOSFET (Metal Oxide Semiconductor Field Effect Transistor).

4. A power supply circuit, comprising:
a semiconductor circuit according to claim 2;
a sixth transistor connected between an input terminal connected to the other end of the first resistor and an output terminal; and
a seventh transistor including one end connected to the second node, the other end connected to the output terminal, and a gate connected to a gate of the sixth transistor.

5. The power supply circuit according to claim 4, further comprising:
a control circuit configured to input a voltage based on a voltage input to the input terminal to the gate of the sixth transistor and a gate of the seventh transistor;
a third resistor connected between the other end of the fifth transistor and the ground node; and
an operational amplifier including a first input end connected to the other end of the fifth transistor and including a second input end to which a second reference voltage is applied, and configured to input, to each of the gate of the sixth transistor and the gate of the seventh transistor, a voltage corresponding to a voltage difference between a voltage at the first input end and a voltage at the second input end.

6. The semiconductor circuit according to claim 1, wherein
the operational amplifier part includes first to fourth switches, eighth to eleventh transistors, and first and second capacitors;
one end of the eighth transistor is connected to the first node via the first switch and to the second node via the second switch;
one end of the ninth transistor is connected to the first node, and a gate thereof is connected to a gate and the other end of the eighth transistor;
the tenth transistor includes one end connected to the other end of the eighth transistor and includes a gate to which the first reference voltage is applied;
the eleventh transistor includes one end connected to the other end of the ninth transistor and includes the other end connected to the other end of the tenth transistor;
the first capacitor is connected to a gate of the eleventh transistor and also connected to one end of the eleventh transistor via the third switch; and
the second capacitor is connected to the gate of the fourth transistor and also connected to one end of the eleventh transistor via the fourth switch.

7. The semiconductor circuit according to claim 6, wherein
the first switch and the third switch are controlled on the basis of a first clock signal; and
the second switch and the fourth switch are controlled on the basis of a second clock signal which is a reverse phase of the first clock signal.

8. The semiconductor circuit according to claim 6, further comprising:
a first resistor including one end connected to the first node;
a second resistor including one end connected to the second node and including the other end connected to the other end of the first resistor;
a first constant current source connected between the other end of the third transistor and a ground node; and
a second constant current source connected between the other end of the eleventh transistor and the ground node.

9. The semiconductor circuit according to claim 6, wherein
the first transistor, the second transistor, the third transistor, the fourth transistor, the fifth transistor, the eighth transistor, the ninth transistor, the tenth transistor, and the eleventh transistor are each a p-type MOSFET (Metal Oxide Semiconductor Field Effect Transistor).

10. The semiconductor circuit according to claim 1, wherein
the operational amplifier part includes first to fourth switches, third and fourth resistors, eighth, ninth, and twelfth transistors, and first and second capacitors;
one end of the third resistor is connected to the first node via the first switch and to the second node via the second switch;
one end of the fourth resistor is connected to the first node;
one end of the eighth transistor is connected to the other end of the third resistor;
the ninth transistor includes one end connected to the other end of the fourth resistor and includes a gate connected to a gate and the other end of the eighth transistor;
one end of the twelfth transistor is connected to the other end of the fourth resistor;
the first capacitor is connected to a gate of the twelfth transistor and also connected to the other end of the ninth transistor via the third switch; and
the second capacitor is connected to the gate of the fourth transistor and also connected to the other end of the ninth transistor via the fourth switch.

11. The semiconductor circuit according to claim 10, wherein
the first switch and the third switch are controlled on the basis of a first clock signal; and
the second switch and the fourth switch are controlled on the basis of a second clock signal which is a reverse phase of the first clock signal.

12. The semiconductor circuit according to claim 10, further comprising:
a first resistor including one end connected to the first node;
a second resistor including one end connected to the second node and including the other end connected to the other end of the first resistor;
a first constant current source connected between the other end of the third transistor and a ground node;
a third constant current source connected between the other end of the eighth transistor and the ground node; and
a fourth constant current source connected between the other end of the ninth transistor and the ground node.

13. The semiconductor circuit according to claim 10, wherein
the first transistor, the second transistor, the third transistor, the fourth transistor, the fifth transistor, the eighth transistor and the ninth transistor are each a p-type MOSFET; and
the twelfth transistor is an n-type MOSFET.

14. The semiconductor circuit according to claim 6, wherein
the operational amplifier part further includes fifth to eighth switches, thirteenth to sixteenth transistors, and a third capacitor;
one end of the thirteenth transistor is connected to the first node via the fifth switch and to the second node via the sixth switch;
the fourteenth transistor includes one end connected to the first node and includes a gate connected to a gate and the other end of the thirteenth transistor;
the fifteenth transistor includes one end connected to the other end of the thirteenth transistor and includes a gate to which the first reference voltage is applied;
the sixteenth transistor includes one end connected to the other end of the fourteenth transistor and also connected to the gate of the fourth transistor via the seventh switch, and includes the other end connected to the other end of the fifteenth transistor; and
the third capacitor is connected to a gate of the sixteenth transistor and also connected to one end of the sixteenth transistor via the eighth switch.

15. The semiconductor circuit according to claim 14, wherein
the first switch, the third switch, the sixth switch, and the seventh switch are controlled on the basis of a first clock signal; and
the second switch, the fourth switch, the fifth switch, and the eighth switch are controlled on the basis of a second clock signal which is a reverse phase of the first clock signal.

16. The semiconductor circuit according to claim 14, further comprising:
a first resistor including one end connected to the first node;
a second resistor including one end connected to the second node and including the other end connected to the other end of the first resistor;
a first constant current source connected between the other end of the third transistor and a ground node;
a second constant current source connected between the other end of the eleventh transistor and the ground node; and
a third constant current source connected between the other end of the sixteenth transistor and the ground node.

17. The semiconductor circuit according to claim 14, wherein
the first transistor, the second transistor, the third transistor, the fourth transistor, the fifth transistor, the eighth transistor, the ninth transistor, the tenth transistor, the eleventh transistor, the thirteenth transistor, the fourteenth transistor, the fifteenth transistor, and the sixteenth transistor are each a p-type MOSFET.

18. The semiconductor circuit according to claim 16, wherein
the operational amplifier part includes a cascode connection.

19. The semiconductor circuit according to claim 18, wherein
the operational amplifier part further includes seventeenth to twenty-second transistors;
the seventeenth transistor is connected between the first switch and the eighth transistor and between the second switch and the eighth transistor;
the eighteenth transistor is connected between the first node and the ninth transistor, and a gate of the eighteenth transistor is connected to a gate of the seventeenth transistor and the other end of the eighth transistor;
the nineteenth transistor includes one end connected to the other end of the first resistor and includes a gate connected to a node connecting the ninth transistor and the eighteenth transistor;
the twentieth transistor is connected between the fifth switch and the thirteenth transistor and between the sixth switch and the thirteenth transistor;
the twenty-first transistor is connected between the first node and the fourteenth transistor, and a gate of the twenty-first transistor is connected to a gate of the twentieth transistor and the other end of the thirteenth transistor;
the twenty-second transistor includes one end connected to the other end of the first resistor and includes a gate connected to a node connecting the fourteenth transistor and the twenty-first transistor;
each of the gate of the eighth transistor and the gate of the ninth transistor is connected, not to the other end of the eighth transistor, but to the other end of the nineteenth transistor; and
each of the gate of the thirteenth transistor and the gate of the fourteenth transistor is connected, not to the other end of the thirteenth transistor, but to the other end of the twenty-second transistor.

20. The semiconductor circuit according to claim 19, wherein
the first transistor, the second transistor, the third transistor, the fourth transistor, the fifth transistor, the eighth transistor, the ninth transistor, the tenth transistor, the eleventh transistor, the thirteenth transistor, the fourteenth transistor, the fifteenth transistor, and the sixteenth transistor are each a p-type MOSFET, and
the seventeenth transistor, the eighteenth transistor, the nineteenth transistor, the twentieth transistor, the twenty-first transistor, and the twenty-second transistor are each an n-type MOSFET.
